(19) United States
(12) Patent Application Publication
(10) Pub. No.: US 2005/0287253 A1
(43) Pub. Date: Dec. 29, 2005

(54) Method for setting the performance of gas-operated cooking equipment as a function of geodetic height

(75) Inventors: Manfred Bucher, Landsberg/Lech (DE); Manfred Lichtenstern, Weil/Petzenhausen (DE); Reiner Otminghaus, Landsberg (DE); Thomas Schreiner, Hurlach (DE); Stefan Rusche, Lamerdingen (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: RATIONAL AG, Landsberg/Lech (DE)

(21) Appl. No.: 11/112,029

(22) Filed: Apr. 22, 2005

(30) Foreign Application Priority Data
Apr. 23, 2004 (DE) 10 2004 020 365.2

(51) Int. Cl. A23L 1/20

(52) U.S. Cl. 426/231

(57) ABSTRACT

A method of adjusting at least one parameter of gas-operated cooking equipment as a function of the site and/or of the height of the site of the cooking equipment includes determining the geodetic height at the site during an initialization step by determining at least one physical parameter or a difference of two physical parameters and adjusting the heat output of at least one combustion system of the cooking equipment. The determined physical parameter may be air pressure, density, the mean ambient temperature, the humidity in the air and/or the boiling point of water and the physical parameter or the difference of the two physical parameters may be determined by starting up at least one functional group of the cooking equipment. The adjustment of the heat output of the combustion system of the cooking equipment may be performed by adjusting the air/fuel mixture in the region of an ignition device of the combustion system.

### RELATED APPLICATION

This patent application claims priority from German application DE 10 2004 020 365.2, which was filed on Apr. 23, 2004, the entire disclosure of which is hereby expressly incorporated herein by reference.

### TECHNICAL FIELD

The present application concerns a method for adjusting the performance of gas-operated cooking equipment as a function of the geodetic height at the site of the cooking equipment.

### DESCRIPTION OF THE RELATED ART

In the unprepublished application DE 103 01 526.4 of the applicant, cooking equipment is described, which is equipped with a satellite-supported location system, so that the site and/or the elevation at the site of the cooking equipment can be determined. Depending on the site detected by the location system and/or depending on the site elevation determined by the location system, the parameters of the cooking equipment can be adapted to the local conditions at the site of the cooking equipment, such as different eating habits, special properties of local foods, or physical parameters such as air pressure, density, mean ambient temperature, humidity in the air, boiling point of the water, water composition, water temperature, water availability, gas quality, electrical energy supply and similar.

On the other hand, a combustion system is known from WO 02/10648 A1 of the applicant, which has an air inlet with a fan, a fuel inlet opening through at least one nozzle opening into the air inlet, with at least one valve, an ignition device for igniting an air/fuel mixture downstream of the nozzle and a control and/or regulating device for adjusting the air/fuel mixture in the region of the ignition device via the speed of the fan, bringing this in working connection with a sensor device in such a way that, depending on the values of air quantities detected with the sensor device, such as air volume flow, air flow-through and/or air pressure, the valve in the fuel inlet can be adjusted.

### SUMMARY OF THE DISCLOSURE

The present system provides a method for setting at least one parameter of gas-operated cooking equipment as a function of its site, in as simple and cost-effective manner as possible, in which, without adding new equipment components, adjustment of the heat output of a combustion system of the cooking equipment at the site can be done automatically during initialization of the cooking equipment.

The present system operates by determining the geodetic height at the site during an initialization step through determination of at least one physical parameter, such as air pressure, density, the mean outside temperature, the humidity in the air and/or the boiling point of water, and/or at least of a difference of two such physical parameters by starting up at least one functional group of the cooking equipment. The system then adjusts the heat output of at least one combustion system of the cooking equipment by adjusting the air/fuel; mixture in the region of an ignition device of the combustion system.

Hereby, preferably the heat output is adjusted by setting the speed of a fan of the combustion system.

Furthermore, it is proposed that the physical parameter be determined under different operating states of the cooking equipment, where the operating states are determined especially by the temperature in a cooking chamber of the cooking equipment and/or by the speed of a fan wheel for circulation of cooking medium, including air and/or steam, especially in the cooking chamber, where preferably a determination is carried out at a cooking chamber temperature of approximately 30°, 100° and 170° for several speeds, especially for five speeds.

It can be provided that the physical parameter for preadjustment of the cooking equipment is determined in the plant and that for adjustment of the cooking equipment the physical parameter is determined at the site. In the adjustment at the site, a comparison is made between the physical parameters determined in the plant and at the site and the result of the comparison is taken into consideration in the adjustment of the air/fuel mixture.

It is proposed that the physical parameter be determined at the site in the cold cooking equipment in which the cooking medium is present at ambient temperature.

Preferred practical examples are characterized by the fact that the boiling point, especially the boiling temperature of water, is determined in a steam generator of the cooking equipment as a physical parameter for the determination of the geodetic height.

Hereby it can be provided that the water is heated until its temperature no longer increases.

Other practical examples are preferably characterized by the fact that the moisture, a differential pressure and/or the density of a cooking medium, including air and/or steam is determined in the cooking chamber and/or fan chamber of the cooking equipment as a physical parameter for the determination of the geodetic height.

It can be provided that the differential pressure between two measured points in the space between a fan wheel in the fan chamber and the wall of the cooking equipment, which faces away from the cooking chamber and is bordering the fan chamber, be determined during operation of the fan wheel.

Finally, it is proposed that the heat output of the combustion system for operation of a steam generator be utilized for heating a cooking medium and/or for charging a heat accumulator.

Thus, the advantage is based on the surprising finding that an automatic adjustment of the combustion system of a cooking equipment can take place at its site especially at the geodetic height at the site, by using at least one functional group of the cooking equipment, whereby, for example, a steam generator or a moisture-measuring device of the cooking equipment can be selected as a functional group in order to determine the geodetic height via the boiling temperature of the water in the steam generator or via the moisture determined in the cooking chamber and/or fan chamber. The determined geodetic height is then used specifically for the adjustment of the speed of the fan of the combustion system.

Details of the moisture-measuring device which can be used in a method according to the invention can be taken, for example, from DE 42 06 845 C2 of the applicant.

### BRIEF DESCRIPTION OF THE DRAWINGS

Other characteristics and advantages of the invention follow from the description below in which two practical examples are explained in detail with the aid of a schematic drawing. The following are shown.

FIG. 1 shows part of a first cooking equipment in which a method of operating gas operated equipment can be performed; and

FIG. 2 shows part of a second cooking equipment in which another method of operating gas operated equipment can be performed.

### DESCRIPTION OF THE PREFERRED EMBODIMENTS

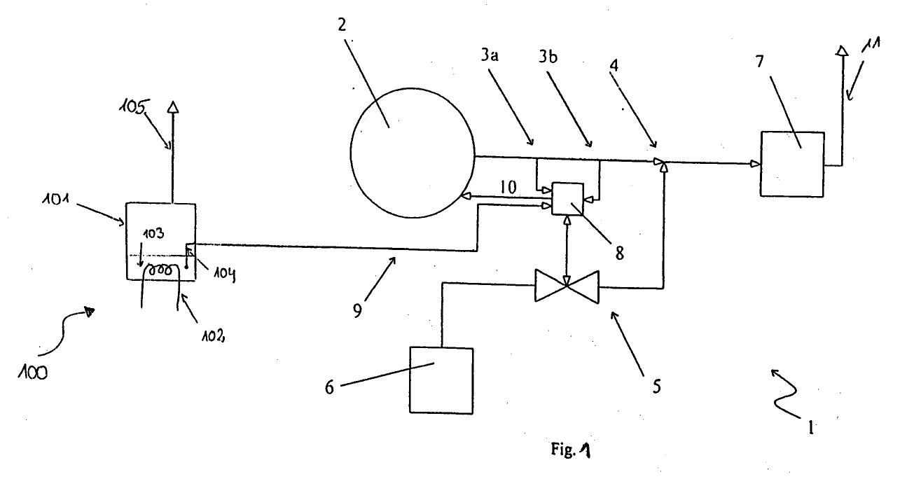

As can be seen from FIG. 1, cooking equipment in which an operating method can be carried out includes a combustion system 1 and a steam generator 100. The cooking equipment is thus gas-driven cooking equipment in which the material to be refined can be refined with hot air and/or steam.

The combustion system 1 in turn includes in its air inlet a fan 2 as well as two pressure-measuring sensors 3a, 3b upstream of a fuel nozzle 4, which can be fed through a fuel source 6 with a valve 5 in-between. Downstream of the fuel nozzle 4 there is an igniter which is not shown, and finally a burner 7 for providing heat to a cooking chamber of the cooking equipment, which is not shown. The pressure-measuring sensors 3a, 3b and the valve are connected to a control device 8, to which control quantities can be introduced through a control quantity line 9 from steam generator 100, while the control device 8 in turn outputs a manipulated variable through the manipulated variable line 10 to the fan 2 and ensures the opening and closing of valve 5, so that a desired heating output can be introduced to the cooking chamber through a heat inlet line 11.

The steam generator 100 in turn includes a housing 101, into which a heating device 102 protrudes for the evaporation of water 103, whereby the boiling temperature of the water 103 can be determined with the aid of a boiling temperature measuring sensor 104 and evaporated water can be introduced to the cooking chamber through a steam line.

When a cooking equipment just described is set up for the first time at a given site, at a specific geodetic height, then the output or rather the heat output of the cooking equipment is adjusted automatically, which, as it is well known, depends on the said height in gas-driven cooking equipment. For this purpose, directly after turning on the cooking equipment, the steam generator 100 is activated, in order to determine the boiling temperature, using the boiling-temperature-measuring sensor 104. From the boiling temperature, which decreases with increasing height above sea level, the geodetic height of the site of the cooking equipment can be calculated. From this, a control quantity is derived which is introduced to the control device 8 via the control quantity line 9 through which then, as a function of the geodetic height, a manipulated variable is calculated, which then again is introduced to the manipulated variable line 10 to fan 2 to adjust its speed.

Naturally, the valve 5 can also be adjusted using the control device 8. However, for reasons of safety, it is preferred that the valve 5 be open only when the speed of the fan 2 has exceeded a previously determined value, which can be determined, for example, with the aid of pressure-measuring sensor 3a, 3b.

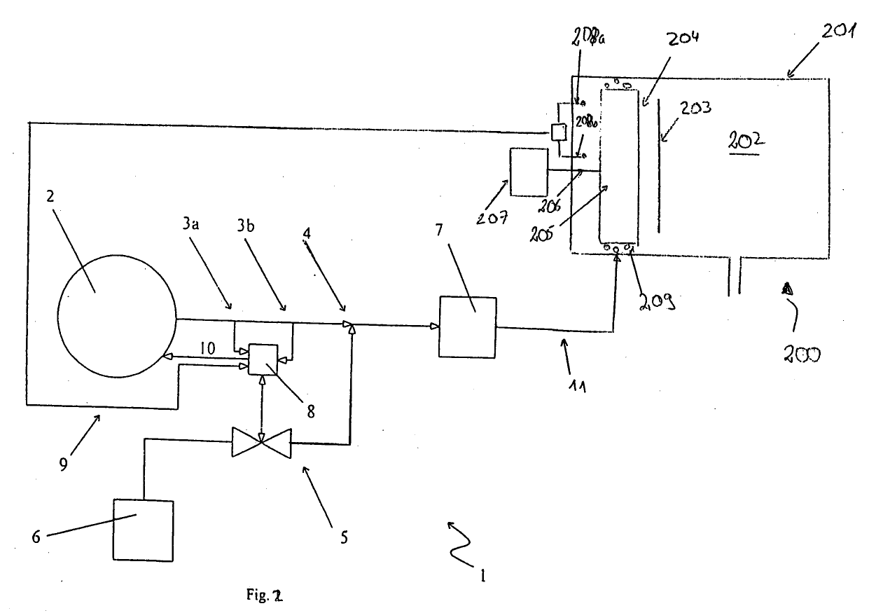

FIG. 2 shows another gas-operated cooking device in a partial manner. This cooking equipment also uses a combustion system 1 as described in connection with FIG. 1, so that, in order to avoid unnecessary repetitions, reference is made to the description given there.

Moreover, FIG. 2 shows the inner cooking chamber 200 which is delineated by a wall 201 and surrounds a cooking chamber 202, which in turn is separated from a fan chamber 204 through an air pipe 203. Within the fan chamber 204, a fan wheel 205 is arranged which can be driven by a motor 207 with a shaft 206 connected in-between. In the intermediate space between the fan wheel 205 and the wall 201 on the side of the fan chamber 204 which faces away from the cooking chamber 202, two pressure-measuring sensors 208a and 208b are arranged, with the aid of which, in case of operation of the fan wheel 205, whirls are produced in the cooking medium within the fan chamber 204 as well as cooking chamber 202, and a pressure difference can be detected from which again the density at the site and thus the geodetic height can be determined. Actually, the determined pressure difference is introduced as a control quantity through control quantity line 9 to control device 8, in which then a determination of the geodetic height and the manipulated variable depending on that takes place. Again, the manipulated variable is the speed of fan 2, which is sent through the manipulated variable line 10 to fan 2. This adjustment of fan 2 provides the production of a desired heat output from burner 7. From burner 7, combustion gases reach through a heat inlet line 11 to a heat exchanger 209 which goes around fan wheel 205 in order to heat the cooking chamber 202 as desired.

Thus, with the method described herein, for the first time, automatic adjustment of the heat output of a gas-operated cooking equipment to a geodetic height is possible without having to introduce any new functional groups in the cooking equipment. Rather, a corresponding adjustment can take place exclusively by carrying out a certain method, preferably within the framework of a software solution. As a result of this, considerable cost and effort is saved.

It was found to be especially advantageous to pre-adjust cooking equipment in the plant, that is, at a known geodetic height and thus at a known air pressure. In this case, the boiling temperatures but also pressure differences under various operating conditions of a cooking equipment can be detected. The operating conditions can differ by different temperatures in the cooking chamber as well as different speeds of the fan wheel in the fan chamber. The different temperatures in the cooking chamber provide a determination with different cooking media, whereby, for example, at 30° C. essentially air is present, while at 100° C. it should be assumed that essentially steam is present. Then adjustment to the geodetic height can take place at the site, after the electricity, gas and water supply has been connected to the cooking equipment. For this purpose then either determination of the boiling temperature or a pressure difference determination can be performed, and then the determined values can be compared with the values obtained in the plant, in order to determine the geodetic height. After determination of the geodetic height, the cooking equipment is then adjusted, especially the speed of the fan of the combustion system of the cooking equipment. Then, as customary, hygienic combustion must be adjusted so that orderly operation of the cooking equipment is ensured.

The characteristics of the invention disclosed in the above description, in the claims, as well as in the drawing can be essential individually or in any arbitrary combination for the realization of the invention in its various embodiments.
1 Combustion system
2 Fan
3a, 3b Pressure-measuring sensor
4 Fuel nozzle
5 Valve
6 Fuel source
7 Burner
8 Control device
9 Control quantity line
10 Manipulated variable line
11 Heat inlet line
100 Steam generator
101 Housing
102 Heating
103 Water
104 Boiling-temperature-measuring sensor
105 Steam line
200 Inner cooking chamber
201 Wall
202 Cooking chamber
203 Air pipe
204 Fan chamber
205 Fan wheel
206 Shaft
207 Motor
208a, 208b Pressure-measuring sensor
209 Heat exchanger

1. A method for setting at least one parameter of a gas-operated cooking equipment as a function of the site and/or site elevation of the cooking equipment, comprising:
determining the geodetic height at the site during an initialization step through the determination of at least one physical parameter, and/or at least one difference of two physical parameters by starting up at least one functional group of the cooking equipment, and
adjusting the heating output of at least one combustion system of the cooking equipment by adjusting the air/fuel mixture in the region of an ignition device of the combustion system.

2. A method according to claim 1, wherein the heating output is adjusted by adjusting the speed of a fan in the combustion system.

3. A method according to claim 1, wherein the physical parameter is determined in different operational states of the cooking equipment.

4. A method according to claim 3, wherein the operational states are determined by the temperature in a cooking chamber of the cooking equipment and/or by the speed of a fan wheel for circulation of the cooking medium.

5. A method according to claim 4, wherein the cooking medium includes air and/or steam.

6. A method according to claim 4, wherein the determination of the operational states is carried out at a cooking chamber temperature of approximately 30° C., 100° C. and 170° C. for several speeds.

7. A method according to claim 6, wherein the several speeds include five speeds.

8. A method according to claim 3, wherein the physical parameter is determined in the plant for preliminary adjustment of the cooking equipment and is then determined on the cooking equipment at the site, whereby in the adjustment on the site a comparison is made between the physical parameter determined in the plant and on the site, and the result of the comparison is taken into consideration in the adjustment of the air/fuel mixture.

9. A method according to claim 8, wherein at the site, the physical parameter is determined in the cold cooking equipment, in which the cooking medium is at ambient temperature.

10. A method according to claim 1, wherein the boiling point of the water is determined in a steam generator of the cooking equipment as the physical parameter for the determination of the geodetic height.

11. A method according to claim 10, wherein the boiling point of water comprises the boiling temperature of water.

12. A method according to claim 10, wherein the water is heated until its temperature no longer increases.

13. A method according to claim 1, wherein one or more of the moisture content, a differential pressure or the density of a cooking medium is measured in the cooking chamber and/or a fan wheel chamber of the cooking equipment as the physical parameter for the determination of the geodetic height.

14. A method according to claim 13, wherein the cooking medium comprises air and/or steam.

15. A method according to claim 13, including determining a differential pressure between two measurement points in an intermediate space between a fan wheel in the fan wheel chamber and in a wall facing away from the cooking chamber and delineating the fan wheel chamber of the cooking equipment, during the operation of the fan wheel.

16. A method according to claim 1, including using the heating output of the combustion system for the operation of a steam generator and/or for heating a cooking medium and/or for loading a heat accumulator.

17. A method according to claim 1, wherein the physical parameter comprises one or more of an air pressure, or a density, or a mean outside temperature, or a humidity in the air or a boiling point of water.
